(19) United States
(12) Patent Application Publication
(10) Pub. No.: US 2021/0095142 A1
(43) Pub. Date: Apr. 1, 2021

(54) Ink Jet Composition

(71) Applicant: Seiko Epson Corporation, Tokyo (JP)

(72) Inventors: Hiroshi TAKIGUCHI, Matsumoto (JP); Hiroaki KIDA, Shiojiri (JP); Kei HIRUMA, Chino (JP); Tomoyuki USHIYAMA, Chino (JP); Masaru TERADA, Suwa (JP); Shintaro ASAI, Matsumoto (JP); Mitsunobu NAKATANI, Shiojiri (JP)

(21) Appl. No.: 17/035,832

(22) Filed: Sep. 29, 2020

(30) Foreign Application Priority Data
Sep. 30, 2019 (JP) 2019-180772

(51) Int. Cl. C09D 11/102; C09D 11/38; C09D 1/00

(52) U.S. Cl. CPC C09D 11/102; C09D 1/00; C09D 11/38

(57) ABSTRACT

An ink jet composition according to the present disclosure contains a plurality of metal particles, a hydrophobic phosphorus surface treatment agent, a polyoxyalkyleneamine compound, and a solvent. The amount of the contained polyoxyalkyleneamine compound is 0.5 parts by mass to 50 parts by mass per 100 parts by mass of the metal particles.

The present application is based on, and claims priority from JP Application Serial Number 2019-180772, filed Sep. 30, 2019, the disclosure of which is hereby incorporated by reference herein in its entirety.

### BACKGROUND

### 1. Technical Field

The present disclosure relates to an ink jet composition.

### 2. Related Art

Hitherto, metal plating, hot-stamping using metal foil, heat transfer using metal foil, and the like have been used as methods for manufacturing decorative articles with a glossy appearance.

However, there is a problem in that it is difficult to form fine patterns by these methods and it is difficult to apply these methods to curved surfaces.

On the other hand, a recording method in which a composition containing pigment or dye is applied to a recording medium by an ink jet process has been used. This method is advantageous in that this method can be used to form a fine pattern and can be successfully used to make a record on a curved surface.

However, in an attempt to simply use metal particles instead of pigment or dye, there are problems that the stability of discharging droplets by the ink jet process is poor; discharge failures are likely to occur; and characteristics, such as gloss, inherent in metals cannot be fully exhibited.

For the purpose of solving the above problems, it has been proposed that metal particles surface-treated with a fluorinated compound are used (see, for example, JP-A-2015-212018).

This enhances the dispersibility of the metal particles to enhance the discharge stability of an ink composition. However, in a case where the ink composition is stored for a long period of time or is stored under severe conditions, there is a problem in that the discharge stability of the ink composition and/or the gloss of a recording article manufactured using the ink composition is significantly reduced.

### SUMMARY

The present disclosure has been made to solve the above problems and can be embodied in the form of an application below.

An ink jet composition according to an application of the present disclosure contains a plurality of metal particles, a hydrophobic phosphorus surface treatment agent, a polyoxyalkyleneamine compound, and a solvent. The amount of the contained polyoxyalkyleneamine compound is 0.5 parts by mass to 50 parts by mass per 100 parts by mass of the metal particles.

In the ink jet composition, the polyoxyalkyleneamine compound is at least one selected from the group consisting of a compound represented by the following formula (1), a salt thereof, a compound represented by the following formula (2), and a slat thereof:

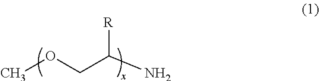

where R is a hydrogen atom or an alkyl group containing three or less carbon atoms, x is an integer of 10 or more, and a plurality of types of oxyalkylene units different in condition of R may be present in Formula (1) and

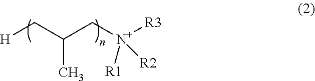

where R1, R2, and R3 are independently an alkyl group containing three or less carbon atoms and n is an integer of 10 or more.

In the ink jet composition, the metal particles are made of aluminium or an aluminium alloy.

In the ink jet composition, the volume-average size of the metal particles is 0.20 μm to 1.00 μm.

In the ink jet composition, the metal particles have a flake shape.

In the ink jet composition, the average thickness of the metal particles is 10 nm to 90 nm.

In the ink jet composition, the hydrophobic phosphorus surface treatment agent is a fluorinated phosphorus compound.

### DESCRIPTION OF EXEMPLARY EMBODIMENTS

Preferred embodiments of the present disclosure are described below in detail.

### 1. Ink Jet Composition

First, an ink jet composition according to an embodiment of the present disclosure is described.

Hitherto, metal plating, hot-stamping using metal foil, heat transfer using metal foil, and the like have been used as methods for manufacturing decorative articles with a glossy appearance.

However, there is a problem in that it is difficult to form fine patterns by these methods and it is difficult to apply these methods to curved surfaces.

On the other hand, a recording method in which a composition containing pigment or dye is applied to a recording medium by an ink jet process has been used. This method is advantageous in that this method can be used to form a fine pattern and can be successfully used to make a record on a curved surface.

However, in an attempt to simply use metal particles instead of pigment or dye, there are problems that the stability of discharging droplets by the ink jet process is poor; discharge failures are likely to occur; and characteristics, such as gloss, inherent in metals cannot be fully exhibited.

For the purpose of solving the above problems, it has been proposed that metal particles surface-treated with a fluorinated compound are used. This enhances the discharge stability of an ink composition. However, in a case where the ink composition is stored for a long period of time or is stored under severe conditions, there is a problem in that the discharge stability of the ink composition and/or the gloss of a recording article manufactured using the ink composition is significantly reduced.

Therefore, the inventor has carried out intensive investigations for the purpose of solving the above problems, leading to the present disclosure. That is, the ink jet composition contains a plurality of metal particles, a hydrophobic phosphorus surface treatment agent, a polyoxyalkyleneamine compound, and a solvent. The amount of the contained polyoxyalkyleneamine compound is 0.5 parts by mass to 50 parts by mass per 100 parts by mass of the metal particles.

This allows an advantage due to the use of the ink jet process to be obtained and also allows the discharge stability of droplets in a relatively short period of time after the production of the ink jet composition, the dispersion stability of the metal particles in the ink jet composition, and the gloss of the recording article manufactured using the ink jet composition to be excellent. Moreover, even after the ink jet composition is stored for a long period of time or is stored under severe conditions, the discharge stability of droplets, the dispersion stability of the metal particles in the ink jet composition, and the gloss of the recording article manufactured using the ink jet composition can be made sufficiently excellent.

The reason why these excellent effects are obtained is probably as described below.

That is, since both the hydrophobic phosphorus surface treatment agent and the polyoxyalkyleneamine compound are components contributing to enhancing the dispersion stability of the metal particles, containing the hydrophobic phosphorus surface treatment agent and the polyoxyalkyleneamine compound allows the dispersion stability of the metal particles in the ink jet composition to be excellent. In particular, it is conceivable that, since the hydrophobic phosphorus surface treatment agent and the polyoxyalkyleneamine compound are contained, these components act synergistically to allow the dispersion stability of the metal particles in the ink jet composition to be excellent. In detail, since both the hydrophobic phosphorus surface treatment agent and the polyoxyalkyleneamine compound are contained, the attachment of these components to the surfaces of the metal particles is promoted and the detachment and/or exchange reaction of these components attached to the surfaces of the metal particles are effectively prevented. As a result, it is conceivable that, even after the ink jet composition is stored for a long period of time or is stored under severe conditions, the metal particles can be successfully dispersed and the stability of discharging the ink jet composition by the ink jet process and the gloss of the recording article manufactured using the ink jet composition can be made excellent. Metal particles treated with the hydrophobic phosphorus surface treatment agent only aggregate and are poor in dispersion stability; hence, printing properties are likely to be reduced and the gloss of a recording medium is likely to be reduced. However, it is conceivable that using the polyoxyalkyleneamine compound enables the aggregation of the metal particles to be prevented and also enables printing properties and the glossiness to be maintained high.

When the above conditions are not satisfied, no satisfactory results are obtained.

For example, if the ink jet composition does not contain the polyoxyalkyleneamine compound, then a problem below occurs even though the ink jet composition contains the hydrophobic phosphorus surface treatment agent. That is, in a short term, the dispersion stability of the metal particles in the ink jet composition can be maintained excellent. However, when the ink composition is stored for a long period of time or is stored under severe conditions, the dispersion stability of the metal particles in the ink jet composition cannot be maintained in a good state. As a result, the stability of discharge by the ink jet process and/or the gloss of a manufactured recording article is significantly reduced.

If the ink jet composition does not contain the hydrophobic phosphorus surface treatment agent, then it is difficult to maintain the dispersion of the metal particles in the ink jet composition in a good state even though the ink jet composition contains the polyoxyalkyleneamine compound. In particular, when the ink composition is stored for a long period of time or is stored under severe conditions, the dispersion state of the metal particles in the ink jet composition is significantly impaired and the stability of discharge by the ink jet process and/or the gloss of a manufactured recording article is significantly reduced.

If the amount of the contained polyoxyalkyleneamine compound is less than the above-mentioned lower limit, then a problem below occurs even though the ink jet composition contains the hydrophobic phosphorus surface treatment agent and the polyoxyalkyleneamine compound. That is, an effect obtained by using the hydrophobic phosphorus surface treatment agent and the polyoxyalkyleneamine compound in combination as described above is not fully exhibited. As a result, when the ink composition is stored for a long period of time or is stored under severe conditions, the dispersion state of the metal particles in the ink jet composition is reduced and the stability of discharge by the ink jet process and/or the gloss of a manufactured recording article is not satisfactory.

Even though the ink jet composition contains the hydrophobic phosphorus surface treatment agent and the polyoxyalkyleneamine compound, if the amount of the contained polyoxyalkyleneamine compound is more than the above-mentioned upper limit, then the adsorption of the hydrophobic phosphorus surface treatment agent on pigment is inhibited, the initial glossiness of a recording article is reduced because the mobility of the metal particles during drying is reduced, and the storage stability of the ink jet composition is poor after the ink jet composition is stored for a long period of time or is stored under severe conditions.

The amount of the polyoxyalkyleneamine compound contained in the ink jet composition may be 0.5 parts by mass to 50 parts by mass per 100 parts by mass of the metal particles and preferably satisfies conditions below. That is, the lower limit of the amount of the contained polyoxyalkyleneamine compound per 100 parts by mass of the metal particles is preferably 1.0 part by mass, more preferably, 5.0 parts by mass, and further more preferably 10.0 parts by mass. The upper limit of the amount of the contained polyoxyalkyleneamine compound per 100 parts by mass of the metal particles is preferably 40.0 parts by mass, more preferably, 35.0 parts by mass, and further more preferably 30.0 parts by mass. This allows the above-mentioned effects to be remarkably exhibited.

The term “ink jet composition” as used herein is a concept that includes ink discharged by the ink jet process and a stock solution used to prepare the ink. In other words, the ink jet composition may be one as-is discharged by the ink jet process or one discharged by the ink jet process after treatment such as dilution.

According to the present disclosure, when the ink jet composition is a stock solution of ink discharged by the ink jet process, the storage stability of the stock solution and, for example, the dispersion stability of the metal particles stored for a long period of time or stored under severe conditions are excellent and the storage stability of ink obtained by diluting the stock solution can be made excellent. When the ink jet composition is the stock solution of the ink discharged by the ink jet process, even after the stock solution is stored for a long period of time or is stored under severe conditions or the ink obtained by diluting the stock solution is stored for a long period of time or is stored under severe conditions, the gloss of a recording article manufactured using the ink obtained by diluting the stock solution can be made excellent.

Components of the ink jet composition are described below.

### 1-1. Metal Particles

The ink jet composition contains the metal particles.

The metal particles have a superficially visible section having at least one portion made of a metal material and are usually those having a surface section made of a metal material.

The metal particles are a component having a significant influence on the appearance of a recording article manufactured using the ink jet composition.

In the ink jet composition, the metal particles have a surface usually provided with the hydrophobic phosphorus surface treatment agent and the polyoxyalkyleneamine compound, which are described below in detail, and are surface-treated with the hydrophobic phosphorus surface treatment agent and the polyoxyalkyleneamine compound.

The metal particles may have at least one region which includes the vicinity of a surface and which is made of a metal material; may be wholly made of, for example, the metal material; or may include a base portion made of a non-metal material and a film which covers the base portion and which is made of the metal material. Each metal particle may be provided with an oxide film such as a passive film on the surface thereof. Hitherto, the above-mentioned problems have occurred even in such metal particles. The application of the present disclosure allows the above-mentioned excellent effects to be obtained.

The metal material, which forms the metal particles, may be single metal or various alloys. Examples of the metal material include aluminium, silver, gold, platinum, nickel, chromium, tin, zinc, indium, titanium, iron, and copper. The metal particles are preferably made of aluminium or an aluminium alloy. The reason why aluminium or the aluminium alloy is preferable is that aluminium and the aluminium alloy have lower density as compared to iron and the like. This allows the settling of particles made of aluminium or the aluminium alloy to proceed very slowly in a case where the particles are dispersed in the ink jet composition. Therefore, the occurrence of concentration homogeneity can be effectively prevented and the ink jet composition can be stored for a long period of time.

In addition, the increase in production cost of a recording article can be suppressed and the gloss and luxurious image of the recording article can be made excellent. Aluminium and the aluminium alloy inherently give particularly excellent gloss among various metal materials. The inventor has found that a problem below occurs when particles made of these materials are used in the ink jet composition. That is, the inventor has found that a problem such as a reduction in discharge stability due to the increase of viscosity by gelation because the storage stability of the ink jet composition becomes particularly low. However, the presence of the hydrophobic phosphorus surface treatment agent and the polyoxyalkyleneamine compound together with the metal particles enables the occurrence of the above problem to be reliably prevented even when particles made of aluminium or the aluminium alloy are used. That is, when the metal particles are made of aluminium or the aluminium alloy, an effect of the present disclosure can be more remarkably exhibited.

The metal particles may have any shape such as a spherical shape, a spindle shape, or a needle shape and preferably have a flake shape.

This enables the metal particles to be arranged on a recording article to which the ink jet composition is applied such that a principal surface of each metal particle follows the surface shape of the recording article. As a result, the gloss and the like inherent in the metal material, which forms the metal particles, can be more effectively exhibited on the obtained recording article, the gloss and luxurious image of a formed print portion can be made particularly excellent, and the abrasion resistance of the recording article can be made particularly excellent. In ink jet compositions containing none of the hydrophobic phosphorus surface treatment agent and the polyoxyalkyleneamine compound, when the metal particles have the flake shape, the storage stability and discharge stability of the ink jet compositions are likely to be particularly low. However, since the ink jet composition contains the hydrophobic phosphorus surface treatment agent and the polyoxyalkyleneamine compound together with the metal particles, the occurrence of such a problem can be reliably prevented even when the metal particles have the flake shape. That is, when the metal particles have the flake shape, an effect of the present disclosure can be more remarkably exhibited.

The term “flake shape” as used herein refers to such a shape that, for example, the plan-view area observed at a predetermined angle is greater than the area observed at a angle perpendicular to the observation direction as is the case with a flat plate shape or a curved plate shape. In particular, the ratio S₁/S₀ of the area observed in a direction in which the projected area is maximum, that is, the plan-view area S₁ (μm²) to the area S₀ (μm²) observed in a direction which is perpendicular to the observation direction and in which the observed area is maximum is preferably 2 or more, more preferably 5 or more, and further more preferably 8 or more. As this value, the average of values calculated for, for example, arbitrary 50 particles which are observed can be used. Observation can be performed using, for example, an electron microscope, an atomic force microscope, or the like.

When the metal particles have the flake shape, the lower limit of the average thickness of the metal particles is not particularly limited and is preferably 10 nm, more preferably 15 nm, and further more preferably 20 nm. When the metal particles have the flake shape, the upper limit of the average thickness of the metal particles is not particularly limited and is preferably 90 nm, more preferably 70 nm, further more preferably 50 nm, and most preferably 30 nm.

This allows an effect due to the fact that the metal particles have the flake shape to be remarkably exhibited.

The lower limit of the volume-average size of the metal particles is not particularly limited and is preferably 0.20 μm, more preferably 0.25 μm, and further more preferably 0.30 μm. The upper limit of the volume-average size of the metal particles is not particularly limited and is preferably 1.00 μm, more preferably 0.90 μm, and further more preferably 0.80 μm.

This allows the storage stability and discharge stability of the ink jet composition to be more excellent and enables the occurrence of unintentional color unevenness in a recording article manufactured using the ink jet composition to be effectively prevented.

The term “volume-average size” as used herein refers to the median diameter of the volume distribution obtained by measuring a particle dispersion by a laser diffraction/scattering method and is the size of particles showing just a median of 50% in the cumulative distribution when a large number of measurement results are expressed as an accumulation of the abundance ratio for each size. When the metal particles have the flake shape, the volume-average size is determined on the basis of the plan-view shape and size of the metal particles.

The lower limit of the diameter D₉₀ of the metal particles, which are contained in the ink jet composition, at a cumulative volume percentage of 90% from the fine particle side is preferably 0.50 μm, more preferably 0.55 μm, and further more preferably 0.60 μm. The upper limit of the diameter D₉₀ of the metal particles, which are contained in the ink jet composition, at a cumulative volume percentage of 90% from the fine particle side is preferably 1.50 μm, more preferably 1.20 μm, and further more preferably 0.95 μm.

This allows the storage stability and discharge stability of the ink jet composition to be more excellent and enables the occurrence of unintentional color unevenness in a recording article manufactured using the ink jet composition to be effectively prevented.

The lower limit of the content of the metal particles in the ink jet composition is not particularly limited and is preferably 0.1% by mass, more preferably 0.2% by mass, and further more preferably 0.3% by mass. The upper limit of the content of the metal particles in the ink jet composition is not particularly limited and is preferably 30% by mass, more preferably 15% by mass, further more preferably 10% by mass, and most preferably 5% by mass.

This allows the stability of discharging the ink jet composition by the ink jet process to be particularly excellent and also allows the gloss of a print portion formed using the ink jet composition to be particularly excellent.

In particular, when the ink jet composition is ink discharged by the ink jet process, the lower limit of the content of the metal particles in the ink is not particularly limited and is preferably 0.1% by mass, more preferably 0.2% by mass, and further more preferably 0.3% by mass. When the ink jet composition is the ink discharged by the ink jet process, the upper limit of the content of the metal particles in the ink is not particularly limited and is preferably 2.4% by mass, more preferably 2.2% by mass, and further more preferably 1.8% by mass.

When the ink jet composition is a stock solution used to prepare the ink discharged by the ink jet process, the lower limit of the content of the metal particles in the stock solution is not particularly limited and is preferably 2.0% by mass, more preferably 2.5% by mass, and further more preferably 3.0% by mass. When the ink jet composition is the stock solution, which is used to prepare the ink discharged by the ink jet process, the lower limit of the content of the metal particles in the stock solution is not particularly limited and is preferably 30% by mass, more preferably 15% by mass, further more preferably 10% by mass, and most preferably 5% by mass.

The metal particles may be manufactured by any method. When the metal particles are made of Al, the metal particles are preferably manufactured in such a manner that a film is formed by a vapor deposition process using Al, followed by crushing the film. This enables the gloss inherent in Al to be effectively expressed in a print portion formed using the ink jet composition and also enables variations in characteristics between the metal particles to be suppressed. Using this manner enables the metal particles to be successfully manufactured even if the metal particles are relatively thin.

In a case where the metal particles are manufactured in this manner, the metal particles can be successfully manufactured by forming the film on, for example, a substrate using Al. The substrate used may be, for example, a plastic film such as a polyethylene terephthalate film. The substrate may have a release agent layer on a film-forming surface thereof.

The film is preferably crushed in such a way that ultrasonic vibration is applied to the film in liquid. This enables the metal particles to be readily and reliably obtained such that the metal particles have such a size as described below and also enables the occurrence of variations in size, shape, and characteristics between the metal particles to be suppressed.

In a case where the film is crushed in the above way, the liquid used may be alcohol such as methanol, ethanol, propanol, or butanol; a hydrocarbon compound such as n-heptane, n-octane, decane, dodecane, tetradecane, toluene, xylene, cymene, durene, indene, dipentene, tetrahydronaphthalene, decahydronaphthalene, or cyclohexylbenzene; an ether compound such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, diethylene glycol monobutyl ether acetate, diethylene glycol n-butyl ether, tripropylene glycol dimethyl ether, triethylene glycol diethyl ether, 1,2-dimethoxyethane, bis(2-methoxyethyl) ether, p-dioxane, or tetrahydrofuran; or a polar compound such as propylene carbonate, γ-butyrolactone, N-methyl-2-pyrrolidone, N,N-dimethylformamide, N,N-dimethylacetamide, dimethyl sulfoxide, cyclohexanone, or acrylonitrile. Using the liquid prevents the unintentional oxidation of the metal particles, allows the production efficiency of the metal particles to be particularly excellent, and allows variations in size, shape, and characteristics between the metal particles to be particularly small.

### 1-2. Hydrophobic Phosphorus Surface Treatment Agent

The ink jet composition contains the hydrophobic phosphorus surface treatment agent.

The hydrophobic phosphorus surface treatment agent may be capable of exhibiting hydrophobic properties as a whole of the hydrophobic phosphorus surface treatment agent in such a state that the hydrophobic phosphorus surface treatment agent is attached to the metal particles. The expression “capable of exhibiting hydrophobic properties” means that the metal particles provided with the hydrophobic phosphorus surface treatment agent become dispersible in an organic solvent. The hydrophobic phosphorus surface treatment agent used may be a phosphorus compound containing a phosphorus atom and may be, for example, a phosphoric, phosphonic, or phosphinic acid derivative. Examples of the derivative include tautomers, esterified products, etherified products, and those in which a hydrogen atom in a structural formula is substituted by an organic substituent. The hydrophobic phosphorus surface treatment agent used may be one used as a surfactant. The hydrophobic phosphorus surface treatment agent preferably contains a hydrophobic atom or atomic group.

Examples of the hydrophobic atom or atomic group include a fluorine atom, an alkyl group containing three or more carbon atoms, and a fluorinated alkyl group. The number of carbon atoms in the alkyl group or the fluorinated alkyl group is preferably three or more, more preferably five or more, and further more preferably eight or more. The upper limit of the number of the carbon atoms therein is not particularly limited and is preferably 30, more preferably 20, and further more preferably 15. The alkyl group or the fluorinated alkyl group is preferably one bonded to a phosphorus atom in a phosphorus surface treatment agent or one obtained by etherifying a hydroxy group bonded to a phosphorus atom in a phosphorus surface treatment agent.

In particular, the hydrophobic phosphorus surface treatment agent is preferably a fluorinated phosphorus compound that is a phosphorus compound containing at least one fluorine atom in its molecule.

This allows hydrophobic properties of the hydrophobic phosphorus surface treatment agent attached to the metal particles to be higher and also allows the dispersion stability of the metal particles in the ink jet composition to be more excellent. A synergistic effect in combination with the polyoxyalkyleneamine compound, which is described below in detail, is remarkably exhibited and the storage stability and discharge stability of the ink jet composition and the gloss of a recording article manufactured using the ink jet composition can be made more excellent. In particular, in a recording article manufactured using the ink jet composition, the metal particles can be successfully arranged in the vicinity of a surface of a print portion and characteristics, such as gloss, inherent in the metal material, which forms the metal particles, can be more effectively exhibited.

When the hydrophobic phosphorus surface treatment agent is the fluorinated phosphorus compound, the fluorinated phosphorus compound preferably has a perfluoroalkyl structure.

This allows the storage stability of the ink jet composition to be more excellent and also allows the gloss and abrasion resistance of a print portion of a recording article manufactured using the ink jet composition to be more excellent.

The ink jet composition may contain a plurality of types of compounds serving as hydrophobic phosphorus surface treatment agents. In this case, the same metal particles may be surface-treated with a plurality of types of hydrophobic phosphorus surface treatment agents. The ink jet composition may contain the metal particles surface-treated with different hydrophobic phosphorus surface treatment agents.

The surface treatment of the metal particles with the hydrophobic phosphorus surface treatment agent may be as follows: for example, before the metal particles are formed by crushing the film, which is made of metal, formed by the vapor deposition process in the liquid as described above, the hydrophobic phosphorus surface treatment agent is added to the liquid.

In a case where the same metal particles are surface-treated with a plurality of types of hydrophobic phosphorus surface treatment agents, the metal particles may be surface-treated in a plurality of steps corresponding to each of the hydrophobic phosphorus surface treatment agents or may be surface-treated with the hydrophobic phosphorus surface treatment agents in the same step.

The lower limit of the content of the hydrophobic phosphorus surface treatment agent in the ink jet composition is not particularly limited and is preferably 0.01% by mass, more preferably 0.02% by mass, and further more preferably 0.04% by mass. The upper limit of the content of the hydrophobic phosphorus surface treatment agent in the ink jet composition is not particularly limited and is preferably 3.0% by mass, more preferably 2.0% by mass, and further more preferably 1.5% by mass.

This allows the stability of discharging the ink jet composition by the ink jet process to be particularly excellent and also allows the gloss of a print portion formed using the ink jet composition to be particularly excellent.

In particular, when the ink jet composition is the ink discharged by the ink jet process, the lower limit of the content of the hydrophobic phosphorus surface treatment agent in the ink is not particularly limited and is preferably 0.01% by mass, more preferably 0.02% by mass, and further more preferably 0.04% by mass. When the ink jet composition is the ink discharged by the ink jet process, the upper limit of the content of the hydrophobic phosphorus surface treatment agent in the ink is not particularly limited and is preferably 1.0% by mass, more preferably 0.7% by mass, and further more preferably 0.5% by mass.

When the ink jet composition is the stock solution, which is used to prepare the ink discharged by the ink jet process, the lower limit of the content of the hydrophobic phosphorus surface treatment agent in the stock solution is not particularly limited and is preferably 0.05% by mass, more preferably 0.10% by mass, and further more preferably 0.20% by mass. When the ink jet composition is the stock solution, which is used to prepare the ink discharged by the ink jet process, the upper limit of the content of the hydrophobic phosphorus surface treatment agent in the stock solution is not particularly limited and is preferably 3.0% by mass, more preferably 2.0% by mass, and further more preferably 1.5% by mass.

Supposing that the content of the metal particles in the ink jet composition is XM (mass percent) and the content of the hydrophobic phosphorus surface treatment agent is XP (mass percent), the lower limit of the value of XP/XM is not particularly limited and is preferably 0.01, more preferably 0.05, and further more preferably 0.06. The upper limit of the value of XP/XM is not particularly limited and is preferably 15, more preferably 12, further more preferably 9.0, still further more preferably 1 or less, and yet still further more preferably 0.1 or less.

This allows the stability of discharging the ink jet composition by the ink jet process to be particularly excellent and also allows the gloss of a print portion formed using the ink jet composition to be particularly excellent.

### 1-3. Polyoxyalkyleneamine Compound

The ink jet composition contains the polyoxyalkyleneamine compound.

The polyoxyalkyleneamine compound may be any amine compound having a polyoxyalkylene structure in its molecule and is preferably at least one selected from the group consisting of a compound represented by the following formula (1), a salt thereof, a compound represented by the following formula (2), and a slat thereof:

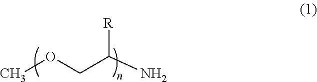

where R is a hydrogen atom or an alkyl group containing three or less carbon atoms, x is an integer of 10 or more, and a plurality of types of oxyalkylene units different in condition of R may be present in Formula (1) and

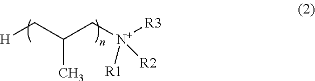

where R1, R2, and R3 are independently an alkyl group containing three or less carbon atoms and n is an integer of 10 or more.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

In Formula (1), R may be a hydrogen atom or an alkyl group containing three or less carbon atoms and is preferably a hydrogen atom or a methyl group and more preferably a compound represented by the following formula:

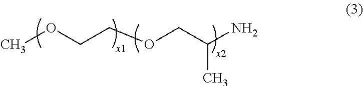

where X1 and X2 are independently an integer of 1 or more and X1+X2 is an integer of 10 or more. In Formula (3), the order of oxyethylene units and oxypropylene units is no object.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

The lower limit of the value of X1/X2 which is the ratio of X1 to X2 in Formula (3), that is, the lower limit of the ratio of the amount of substance of oxyethylene units to the amount of substance of oxypropylene units in the polyoxyalkyleneamine compound is preferably 0.05, more preferably 0.15, and further more preferably 0.70. The upper limit of the value of X1/X2 is preferably 10.00, more preferably 8.00, and further more preferably 6.00.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

In Formula (3), the order of the oxyethylene units and the oxypropylene units is no object as described above. In particular, in Formula (3), an amino group is bonded to an end of the consecutive oxyethylene units and a methyl group is bonded to an end of the consecutive oxypropylene units. An amino group may be bonded to an end of the consecutive oxypropylene units and a methyl group may be bonded to an end of the consecutive oxyethylene units. The compound represented by Formula (3) may be a block copolymer or a random copolymer.

In Formula (2), R1, R2, and R3 may be independently an alkyl group containing three or less carbon atoms and are preferably independently a methyl group or an ethyl group. In particular, it is more preferable that one of R1, R2, and R3 is a methyl group and the other two are ethyl groups.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

A compound in which one of R1, R2, and R3 in Formula (2) is a methyl group and the other two are ethyl groups is represented by the following formula:

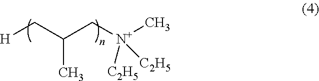

where n is an integer of 10 or more.

The compound represented by Formula (2) and the compound represented by Formula (4) contain an anion, which is not shown in Formula (2) or (4), corresponding to a cation in Formulas (2) and (4). Examples of the anion include a halide ion such as a chloride ion or a bromide ion, a hydroxide ion, a sulfate ion, a nitrate ion, and a phosphate ion.

The lower limit of the weight-average molecular weight of the polyoxyalkyleneamine compound is not particularly limited and is preferably 300, more preferably 500, further more preferably 800, and most preferably 1,000. The upper limit of the weight-average molecular weight of the polyoxyalkyleneamine compound is not particularly limited and is preferably 8,000, more preferably 5,000, and further more preferably 3,000.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

The ink jet composition may contain a plurality of types of compounds serving as polyoxyalkyleneamine compounds. In this case, the same metal particles may be surface-treated with a plurality of types of polyoxyalkyleneamine compounds. The ink jet composition may contain the metal particles surface-treated with different polyoxyalkyleneamine compounds.

The metal particles may be surface-treated with the polyoxyalkyleneamine compound in such a manner that, for example, before the metal particles are formed by crushing the film, which is made of metal, formed by the vapor deposition process in the liquid as described above, the polyoxyalkyleneamine compound is added to the liquid.

In a case where the same metal particles are surface-treated with a plurality of types of polyoxyalkyleneamine compounds, the metal particles may be surface-treated in a plurality of steps corresponding to the polyoxyalkyleneamine compounds or may be surface-treated with the polyoxyalkyleneamine compounds in the same step.

The surface treatment of the metal particles with the polyoxyalkyleneamine compound and the surface treatment of the metal particles with the hydrophobic phosphorus surface treatment agent may be performed in the same step or in different steps. The surface treatment of the metal particles with the polyoxyalkyleneamine compound may be performed before a step of surface-treating the metal particles with the hydrophobic phosphorus surface treatment agent or may be performed after the step of surface-treating the metal particles with the hydrophobic phosphorus surface treatment agent.

The lower limit of the content of the polyoxyalkyleneamine compound in the ink jet composition is not particularly limited and is preferably 0.01% by mass, more preferably 0.06% by mass, and further more preferably 0.10% by mass. The upper limit of the content of the polyoxyalkyleneamine compound in the ink jet composition is not particularly limited and is preferably 3.0% by mass, more preferably 2.0% by mass, and further more preferably 1.5% by mass.

This allows the stability of discharging the ink jet composition by the ink jet process to be particularly excellent and also allows the gloss of a print portion formed using the ink jet composition to be particularly excellent.

In particular, when the ink jet composition is the ink discharged by the ink jet process, the lower limit of the content of the polyoxyalkyleneamine compound in the ink is not particularly limited and is preferably 0.01% by mass, more preferably 0.06% by mass, and further more preferably 0.10% by mass. When the ink jet composition is the ink discharged by the ink jet process, the upper limit of the content of the polyoxyalkyleneamine compound in the ink is not particularly limited and is preferably 1.0% by mass, more preferably 0.70% by mass, and further more preferably 0.50% by mass.

When the ink jet composition is the stock solution, which is used to prepare the ink discharged by the ink jet process, the lower limit of the content of the polyoxyalkyleneamine compound in the stock solution is not particularly limited and is preferably 0.05% by mass, more preferably 0.30% by mass, and further more preferably 0.50% by mass. When the ink jet composition is the stock solution, which is used to prepare the ink discharged by the ink jet process, the lower limit of the content of the polyoxyalkyleneamine compound in the stock solution is not particularly limited and is preferably 3.0% by mass, more preferably 2.0% by mass, and further more preferably 1.5% by mass.

Supposing that the content of the hydrophobic phosphorus surface treatment agent in the ink jet composition is XP (mass percent) and the content of the polyoxyalkyleneamine compound is XA (mass percent), the lower limit of the value of XA/XP is not particularly limited and is preferably 0.10, more preferably 0.40, and further more preferably 2.0. The upper limit of the value of XA/XP is not particularly limited and is preferably 10.0, more preferably 8.0, and further more preferably 6.0.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions. (1-4) Solvent

The ink jet composition contains the solvent. The solvent has a function as a dispersion medium for mainly dispersing the metal particles.

Since the ink jet composition contains the solvent, the ink jet composition can be discharge by the ink jet process. The ink jet composition is preferably a solvent-based composition. The solvent-based composition is a composition which contains the solvent as a solvent component of the composition and in which water is not a solvent component. The content of the solvent in the solvent-based composition is preferably 10% by mass or more and more preferably 30% by mass or more. The solvent is preferably an organic solvent. The content of water in the solvent-based composition is preferably 1% by mass or less and more preferably 0.5% by mass or less.

The solvent is preferably composed of a liquid component other than water and is usually composed of an organic medium. The solvent used may be, for example, an ester compound, an ether compound, a hydroxy ketone, a dicarbonate, a cyclic amide compound, or the like. In particular, examples of a compound capable of being used as a solvent include 2-(2-methoxy-1-methylethoxy)-1-methylethyl acetate, triethylene glycol dimethyl ether, triethylene glycol diacetate, diethylene glycol monoethyl ether acetate, 4-methyl-1,3-dioxolane-2-one, bis(2-butoxyethyl) ether, dimethyl glutarate, ethylene glycol di-n-butyrate, 1,3-butylene glycol diacetate, diethylene glycol monobutyl ether acetate, tetraethylene glycol dimethyl ether, 1,6-diacetoxyhexane, tripropylene glycol monomethyl ether, butoxypropanol, diethylene glycol methyl ethyl ether, diethylene glycol methyl butyl ether, triethylene glycol methyl ethyl ether, triethylene glycol methyl butyl ether, dipropylene glycol monomethyl ether acetate, diethylene glycol dimethyl ether, ethyl 3-ethoxypropionate, diethylene glycol ethyl methyl ether, 3-methoxybutyl acetate, diethylene glycol diethyl ether, ethyl octoate, ethylene glycol monobutyl ether acetate, ethylene glycol monobutyl ether, cyclohexyl acetate, ethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, diacetin, dipropylene glycol mono-n-propyl ether, polyethylene glycol monomethyl ether, butyl glycolate, ethylene glycol monohexyl ether, dipropylene glycol mono-n-butyl ether, N-methyl-2-pyrrolidone, triethylene glycol butyl methyl ether, bis(2-propoxyethyl) ether, diethylene glycol diacetate, diethylene glycol butyl methyl ether, diethylene glycol butyl ethyl ether, diethylene glycol butyl propyl ether, diethylene glycol ethyl propyl ether, diethylene glycol methyl propyl ether, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl methyl ether, triethylene glycol ethyl propyl ether, triethylene glycol methyl propyl ether, dipropylene glycol methyl ether acetate, n-nonyl alcohol, diethylene glycol mono-normal-butyl ether, triethylene glycol monomethyl ether, ethylene glycol 2-ethylhexyl ether, triethylene glycol monoethyl ether, diethylene glycol monohexyl ether, triethylene glycol monobutyl ether, diethylene glycol mono-2-ethylhexyl ether, tripropylene glycol mono-n-butyl ether, butyl cellosolve acetate, and γ-butyrolactone. These may be used alone or in combination.

In particular, the solvent preferably contains at least one selected from the group consisting of diethylene glycol diethyl ether, diethylene glycol methyl ethyl ether, and triethylene glycol monobutyl ether and more preferably at least one of diethylene glycol diethyl ether and diethylene glycol methyl ethyl ether.

This allows the storage stability of the ink jet composition to be more excellent and also allows the discharge stability of ink jet composition and the gloss of a recording article manufactured using the ink jet composition to be more excellent after the ink jet composition is stored for a long period of time or is stored under severe conditions.

The sum of the content of diethylene glycol diethyl ether in the solvent, which is contained in the ink jet composition, and the content of diethylene glycol methyl ethyl ether in the solvent is preferably 40% by mass or more, more preferably 50% by mass or more, and further more preferably 70% by mass or more. This allows the above-mentioned effects to be more remarkably exhibited.

The lower limit of the content of the solvent in the ink jet composition is not particularly limited and is preferably 50.0% by mass, more preferably 60.0% by mass, and further more preferably 70.0% by mass. The upper limit of the content of the solvent in the ink jet composition is not particularly limited and is preferably 99.8% by mass, more preferably 99.5% by mass, and further more preferably 99.0% by mass.

In particular, when the ink jet composition is the ink discharged by the ink jet process, the lower limit of the content of the solvent in the ink is not particularly limited and is preferably 70.0% by mass, more preferably 80.0% by mass, and further more preferably 85.0% by mass. When the ink jet composition is the ink discharged by the ink jet process, the upper limit of the content of the solvent in the ink is not particularly limited and is preferably 99.8% by mass, more preferably 99.5% by mass, and further more preferably 99.0% by mass.

When the ink jet composition is the stock solution, which is used to prepare the ink discharged by the ink jet process, the lower limit of the content of the solvent in the stock solution is not particularly limited and is preferably 50.0% by mass, more preferably 60.0% by mass, and further more preferably 70.0% by mass. When the ink jet composition is the stock solution, which is used to prepare the ink discharged by the ink jet process, the upper limit of the content of the solvent in the stock solution is not particularly limited and is preferably 97.0% by mass, more preferably 96.0% by mass, and further more preferably 95.0% by mass.

### (1-5) Other Components

The ink jet composition may contain a component other than those described above. Examples of the component include a leveling agent, a binder, a polymerization promoter, a polymerization inhibitor, a photopolymerization initiator, a dispersant, a surfactant, a penetration enhancer, a humectant, a colorant, a fixative, a fungicide, a preservative, an oxidation inhibitor, a chelating agent, a thickening agent, and a sensitizer.

The binder, which may be resin, is preferably an acrylic resin, an ester resin, a urethanic resin, or the like and more preferably the acrylic resin. When the ink jet composition contains the binder, the content of the binder in the ink jet composition is preferably 0.1% by mass or more and is preferably 1% by mass or less and more preferably 0.5% by mass or less.

The surfactant is preferably a silicone surfactant, a fluorinated surfactant, an acetylene glycol surfactant, or the like and particularly preferably the silicone surfactant. When the ink jet composition contains the surfactant, the content of the surfactant in the ink jet composition is preferably 0.1% by mass or more and is preferably 1% by mass or less and more preferably 0.5% by mass or less.

The ink jet composition may contain a small amount of water in addition to the above-mentioned solvent. The content of water in the ink jet composition is preferably 1.0% by mass or less, more preferably 0.5% by mass or less, and further more preferably 0.1% by mass or less.

The upper limit of the viscosity of the ink jet composition at 20° C. is not particularly limited and is preferably 25 mPa·s and more preferably 15 mPa·s as measured in accordance with JIS Z 8809 using a vibrational viscometer. The lower limit of the viscosity of the ink jet composition at 20° C. is not particularly limited and is preferably 3 mPa·s as measured in accordance with JIS Z 8809 using the vibrational viscometer. This enables the ink jet composition to be successfully discharged by the ink jet process.

### 2. Recording Article

Next, a recording article used in the present disclosure is described.

The recording article is one manufactured by applying the above-mentioned ink jet composition to a recording medium by the ink jet process.

The recording article is excellent in gloss and includes a print portion protected from the occurrence of defects.

The recording medium used may be any medium and may be an absorbent or non-absorbent medium. The recording medium used may be, for example, paper such as plain paper or ink jet paper, a plastic material, metal, ceramic, wood, a seashell, natural fiber such as cotton or wool, polyester, synthetic fiber, nonwoven fabric, or the like. The shape of the recording medium is not particularly limited and may be any shape such as a sheet shape.

A system of the ink jet process may be a piezoelectric system, a system for discharging ink using bubbles generated by heating the ink, or the like and is preferably the piezoelectric system from the viewpoint that the ink jet composition is unlikely to be altered.

A known droplet-discharging apparatus can be used to discharge the ink jet composition by the ink jet process.

The recording article may be one for any purpose and may be, for example, a decorative article or an application other than the decorative article. Examples of the recording article include vehicle interior parts such as console lids, switch bases, center clusters, interior panels, emblems, center consoles, and meter face plates; operation sections of various electronic devices; decorative sections offering decorative properties; and display articles such as indicators and logos.

While the present disclosure has been described above with reference to preferred embodiments, the present disclosure is not limited to the preferred embodiments. Examples

Next, particular examples of the present disclosure are described.

### 3. Production of Stock Solution for Producing Ink-Jet Ink as Ink Jet Composition

### EXAMPLE A1

First, a polyethylene terephthalate film having a smooth surface and a surface roughness Ra of 0.02 μm or less was prepared.

Next, a whole surface of the polyethylene terephthalate film was coated with a release resin solubilized with acetone using a roll coater, whereby a release layer was formed thereon.

The polyethylene terephthalate film provided with the release layer was transported into a vacuum evaporation system at a rate of 5 m/s, followed by forming an Al film with a thickness of 17.4 nm under reduced pressure.

Next, the polyethylene terephthalate film provided with the Al film was immersed in tetrahydrofuran and a 40 kHz ultrasonic vibration was applied thereto, whereby a dispersion of a metal powder which was a cluster of metal particles made of Al.

Next, tetrahydrofuran was removed from the dispersion using a centrifuge and diethylene glycol diethyl ether was added to the dispersion, whereby a suspension with a metal powder content of 5% by mass was obtained.

Next, the suspension was treated with a circulating high-power ultrasonic crusher, whereby the metal particles was crushed to a predetermined size. In this treatment, a 20 kHz ultrasonic wave was applied to the suspension.

Next, a polyoxyalkyleneamine compound represented by Formula (3) was added to the suspension, followed by heat treatment at 55° C. for one hour under the irradiation of a 40 kHz ultrasonic wave, whereby the aggregation of the metal particles was broken such that the metal particles were dispersed in the form of primary particles. The polyoxyalkyleneamine compound used was a block copolymer which contained an amino group bonded to an end of consecutive oxyethylene units and a methyl group bonded to an end of consecutive oxypropylene units, which satisfied a condition that X1/X2 was 3.1 for X1 and X2 in Formula (3), and which had a weight-average molecular weight of 2,000.

Furthermore, FHP serving as a fluorinated phosphorus compound which was a hydrophobic phosphorus surface treatment agent was added to the suspension. FHP was a compound represented by the formula CF₃(CF₂)₅(CH₂)₂P(O)—(OH)₂. The suspension was heat-treated at 55° C. for three hours under the irradiation of a 28 kHz ultrasonic wave, whereby a stock solution for producing ink-jet inks was obtained.

The volume-average size of the metal particles contained in the obtained stock solution for producing ink-jet inks was 0.49 μm. The diameter D₉₀ of the metal particles contained in the stock solution for producing ink-jet inks at a cumulative volume percentage of 90% from the fine particle side was 0.80 μm.

### EXAMPLES A2 to A18

Stock solutions for producing ink-jet inks were produced in substantially the same manner as that used in Example A1 except that metal powders were composed as shown in Tables 1 and 2 and the type and proportion of raw materials used to prepare the stock solutions for producing ink-jet inks were changed so as to give a composition shown in Tables 1 and 2.

### COMPARATIVE EXAMPLES A1 to A5

Stock solutions for producing ink-jet inks were produced in substantially the same manner as that used in Example A1 except that metal powders were composed as shown in Table 2 and the type and proportion of raw materials used to prepare the stock solutions for producing ink-jet inks were changed so as to give compositions shown in Table 2.

For each of the examples and the comparative examples, the composition of the metal powder contained in the stock solution for producing ink-jet inks and the composition of the stock solution for producing ink-jet inks were summarized in Tables 1 and 2. In Tables 1 and 2, diethylene glycol diethyl ether was denoted as “DEDG”, the above one serving as a fluorinated phosphorus compound which was a hydrophobic phosphorus surface treatment agent was denoted as “FHP”; JP-513 (isotridecyl acid phosphate produced by Johoku Chemical Co., Ltd.) serving as an alkyl phosphorus compound which was a hydrophobic phosphorus surface treatment agent was denoted as “JP-513”; a polyoxyalkyleneamine compound represented by Formula (3), the polyoxyalkyleneamine compound satisfying a condition that X1/X2 was 3.1 for X1 and X2 in Formula (3) and having a weight-average molecular weight of 2,000, was denoted as “POAA1”; a polyoxyalkyleneamine compound represented by Formula (3), the polyoxyalkyleneamine compound satisfying a condition that X1/X2 was 0.11 for X1 and X2 in Formula (3) and having a weight-average molecular weight of 600, was denoted as “POAA2”; a polyoxyalkyleneamine compound represented by Formula (3), the polyoxyalkyleneamine compound satisfying a condition that X1/X2 was 6.33 for X1 and X2 in Formula (3) and having a weight-average molecular weight of 1,000, was denoted as “POAA3”; a polyoxyalkyleneamine compound represented by Formula (3), the polyoxyalkyleneamine compound satisfying a condition that X1/X2 was 7.25 for X1 and X2 in Formula (3) and having a weight-average molecular weight of 3,000, was denoted as “POAA4”; a polyoxyalkyleneamine compound represented by Formula (1), the polyoxyalkyleneamine compound containing a methyl group represented by R in Formula (1) and having a weight-average molecular weight of 3,000, was denoted as “POAAS”; a polyoxyalkyleneamine compound, represented by Formula (4), having a weight-average molecular weight of 5,000 was denoted as “POAA6”; a polyoxyalkyleneamine compound, represented by Formula (4), having a weight-average molecular weight of 3,000 was denoted as “POAA7”; and Disperbyk-102 (produced by BYK Chemie Japan K.K.), which was not a hydrophobic phosphorus surface treatment agent or a polyoxyalkyleneamine compound, was denoted as “BYK102”. Incidentally, each of POAA1 to POAA5 was a block copolymer containing an amino group bonded to an end of consecutive oxyethylene units and a methyl group bonded to an end of consecutive oxypropylene units. For the metal powder contained in the stock solution, prepared in each example, for producing ink-jet inks, arbitrary 50 metal particles were observed. The ratio of the area observed in a direction in which the projected area was maximum, that is, the plan-view area S₁ (μm²) to the area S₀ (μm²) observed in a direction which was perpendicular to the observation direction and in which the observed area was maximum, that is, S₁/S₀ was determined, followed by determining the average thereof, resulting in that the average of S₁/S₀ was 19 or more. The average particle sizes D50 and D90 in Tables 1 and 2 were measured using a laser diffraction/scattering particle size distribution analyzer (Microtrac MT-3000, manufactured by Microtrac BEL Corp.).

TABLE 1

| | | | | | | Hydrophobic | | |
|---|---|---|---|---|---|---|---|---|
| | | | | | | phosphorus surface | | Polyoxyalkyleneamine |
| | Metal particles | | | | Solvent | treatment agent | | compound |
| | | Average | | | DEDG | FHP | JP513 | POAA1 |
| | | particle | | Content | Content | Content | Content | Content |
| | Thickness | size D50 | D90 | [mass | [mass | [mass | [mass | [mass |
| | [nm] | [μm] | [μm] | percent] | percent] | percent] | percent] | percent] |
| Example A1 | 17.4 | 0.49 | 0.80 | 5.0 | 94.6 | 0.3 | 0.0 | 0.1 |
| Example A2 | 17.4 | 0.49 | 0.80 | 5.0 | 93.7 | 0.3 | 0.0 | 1.0 |
| Example A3 | 17.4 | 0.49 | 0.80 | 5.0 | 92.2 | 0.3 | 0.0 | 2.5 |
| Example A4 | 17.4 | 0.49 | 0.80 | 5.0 | 93.7 | 0.3 | 0.0 | 0.0 |
| Example A5 | 17.4 | 0.49 | 0.80 | 5.0 | 93.7 | 0.3 | 0.0 | 0.0 |
| Example A6 | 17.4 | 0.49 | 0.80 | 5.0 | 93.7 | 0.3 | 0.0 | 0.0 |
| Example A7 | 17.4 | 0.49 | 0.80 | 5.0 | 93.7 | 0.3 | 0.0 | 0.0 |
| Example A8 | 17.4 | 0.49 | 0.80 | 5.0 | 93.7 | 0.3 | 0.0 | 0.0 |
| Example A9 | 17.4 | 0.49 | 0.80 | 5.0 | 93.7 | 0.3 | 0.0 | 0.0 |
| Example A10 | 17.4 | 0.39 | 0.75 | 5.0 | 93.7 | 0.0 | 0.3 | 1.0 |
| Example A11 | 17.4 | 0.39 | 0.75 | 5.0 | 93.7 | 0.3 | 0.0 | 1.0 |
| Example A12 | 17.4 | 0.78 | 1.10 | 5.0 | 93.7 | 0.3 | 0.0 | 1.0 |
| Example A13 | 14.5 | 0.47 | 0.80 | 5.0 | 93.6 | 0.4 | 0.0 | 1.0 |

| | | | | | | | Another |
|---|---|---|---|---|---|---|---|
| | Polyoxyalkyleneamine compound | | | | | | dispersant |
| | POAA2 | POAA3 | POAA4 | POAA5 | POAA6 | POAA7 | BYK102 |
| | Content | Content | Content | Content | Content | Content | Content |
| | [mass | [mass | [mass | [mass | [mass | [mass | [mass |
| | percent] | percent] | percent] | percent] | percent] | percent] | percent] |
| Example A1 | 0.0 | 0.0 | 0.0 | 0.0 | 0.0 | 0.0 | 0.0 |
| Example A2 | 0.0 | 0.0 | 0.0 | 0.0 | 0.0 | 0.0 | 0.0 |
| Example A3 | 0.0 | 0.0 | 0.0 | 0.0 | 0.0 | 0.0 | 0.0 |
| Example A4 | 1.0 | 0.0 | 0.0 | 0.0 | 0.0 | 0.0 | 0.0 |
| Example A5 | 0.0 | 1.0 | 0.0 | 0.0 | 0.0 | 0.0 | 0.0 |
| Example A6 | 0.0 | 0.0 | 1.0 | 0.0 | 0.0 | 0.0 | 0.0 |
| Example A7 | 0.0 | 0.0 | 0.0 | 1.0 | 0.0 | 0.0 | 0.0 |
| Example A8 | 0.0 | 0.0 | 0.0 | 0.0 | 1.0 | 0.0 | 0.0 |
| Example A9 | 0.0 | 0.0 | 0.0 | 0.0 | 0.0 | 1.0 | 0.0 |
| Example A10 | 0.0 | 0.0 | 0.0 | 0.0 | 0.0 | 0.0 | 0.0 |
| Example A11 | 0.0 | 0.0 | 0.0 | 0.0 | 0.0 | 0.0 | 0.0 |
| Example A12 | 0.0 | 0.0 | 0.0 | 0.0 | 0.0 | 0.0 | 0.0 |
| Example A13 | 0.0 | 0.0 | 0.0 | 0.0 | 0.0 | 0.0 | 0.0 |

TABLE 2

| | | | | | | Hydrophobic | | |
|---|---|---|---|---|---|---|---|---|
| | | | | | | phosphorus surface | | Polyoxyalkyleneamine |
| | Metal particles | | | | Solvent | treatment agent | | compound |
| | | Average | | | DEDG | FHP | JP513 | POAA1 |
| | | particle | | Content | Content | Content | Content | Content |
| | Thickness | size D50 | D90 | [mass | [mass | [mass | [mass | [mass |
| | [nm] | [μm] | [μm] | percent] | percent] | percent] | percent] | percent] |
| Example A14 | 20.0 | 0.49 | 0.80 | 5.0 | 93.7 | 0.3 | 0.0 | 1.0 |
| Example A15 | 17.4 | 0.49 | 0.80 | 5.0 | 93.7 | 0.3 | 0.0 | 0.5 |
| Example A16 | 17.4 | 0.49 | 0.80 | 5.0 | 93.7 | 0.3 | 0.0 | 0.5 |
| Example A17 | 17.4 | 0.49 | 0.80 | 5.0 | 93.6 | 0.3 | 0.0 | 1.0 |
| Example A18 | 17.4 | 0.49 | 0.80 | 5.0 | 93.7 | 0.3 | 0.0 | 0.4 |
| Comparative | 17.4 | 0.49 | 0.80 | 5.0 | 94.7 | 0.3 | 0.0 | 0.0 |
| Example A1 | | | | | | | | |
| Comparative | 17.4 | 0.49 | 0.80 | 5.0 | 94.69 | 0.3 | 0.0 | 0.01 |
| Example A2 | | | | | | | | |
| Comparative | 17.4 | 0.49 | 0.80 | 5.0 | 89.7 | 0.3 | 0.0 | 5.0 |
| Example A3 | | | | | | | | |
| Comparative | 17.4 | 0.49 | 0.80 | 5.0 | 93.7 | 0.3 | 0.0 | 0.0 |
| Example A4 | | | | | | | | |
| Comparative | 17.4 | 0.49 | 0.80 | 5.0 | 93.0 | 0.0 | 0.0 | 1.0 |
| Example A5 | | | | | | | | |

| | | | | | | | Another |
|---|---|---|---|---|---|---|---|
| | Polyoxyalkyleneamine compound | | | | | | dispersant |
| | POAA2 | POAA3 | POAA4 | POAA5 | POAA6 | POAA7 | BYK102 |
| | Content | Content | Content | Content | Content | Content | Content |
| | [mass | [mass | [mass | [mass | [mass | [mass | [mass |
| | percent] | percent] | percent] | percent] | percent] | percent] | percent] |
| Example A14 | 0.0 | 0.0 | 0.0 | 0.0 | 0.0 | 0.0 | 0.0 |
| Example A15 | 0.0 | 0.0 | 0.5 | 0.0 | 0.0 | 0.0 | 0.0 |
| Example A16 | 0.0 | 0.0 | 0.0 | 0.0 | 0.5 | 0.0 | 0.0 |
| Example A17 | 0.0 | 0.0 | 0.0 | 0.0 | 0.0 | 0.0 | 0.1 |
| Example A18 | 0.0 | 0.3 | 0.3 | 0.0 | 0.0 | 0.0 | 0.0 |
| Comparative | 0.0 | 0.0 | 0.0 | 0.0 | 0.0 | 0.0 | 0.0 |
| Example A1 | | | | | | | |
| Comparative | 0.0 | 0.0 | 0.0 | 0.0 | 0.0 | 0.0 | 0.0 |
| Example A2 | | | | | | | |
| Comparative | 0.0 | 0.0 | 0.0 | 0.0 | 0.0 | 0.0 | 0.0 |
| Example A3 | | | | | | | |
| Comparative | 0.0 | 0.0 | 0.0 | 0.0 | 0.0 | 0.0 | 1.0 |
| Example A4 | | | | | | | |
| Comparative | 0.0 | 0.0 | 0.0 | 0.0 | 0.0 | 0.0 | 1.0 |
| Example A5 | | | | | | | |

### 4. Production of Ink-Jet Ink as Ink Jet Composition Example B1

A portion of the stock solution, prepared in Example Al, for producing ink-jet inks; diethylene glycol diethyl ether; triethylene glycol monobutyl ether; γ-butyrolactone; BYK-333 (a silicon surfactant produced by BYK Chemie Japan K.K.) serving as a surfactant; and UC-3000 (an acrylic resin produced by TOAGOSEI Co., Ltd.) serving as a binder were mixed at a predetermined ratio, whereby an ink-jet ink, having a composition shown in Table 3, serving as an ink jet composition was produced.

### EXAMPLES B2 TO B22

Ink-jet inks were produced in substantially the same manner as that used in Example B1 except that the stock solutions, prepared in the other examples, for producing ink-jet inks were used instead of the stock solution, prepared in Example Al, for producing ink-jet inks as shown in Tables 3 and 4 and the type and proportion of raw materials mixed with the stock solutions for producing ink-jet inks were changed so as to give compositions shown in Tables 3 and 4.

### COMPARATIVE EXAMPLES B1 TO B5

Ink-jet inks were produced in substantially the same manner as that used in Example B1 except that the stock solutions, prepared in Comparative Examples A1 to A5, for producing ink-jet inks were used instead of the stock solution, prepared in Example A1, for producing ink-jet inks as shown in Table 4 and the type and proportion of raw materials mixed with the stock solutions for producing ink-jet inks were adjusted so as to give compositions shown in Table 4.

For the examples and the comparative examples, the compositions of the ink-jet inks were summarized in Tables 3 and 4. In Tables 3 and 4, diethylene glycol diethyl ether was denoted as “DEDG”, diethylene glycol methyl ethyl ether was denoted as “MEDG”, triethylene glycol monobutyl ether was denoted as “TEGMBE”, γ-butyrolactone was denoted as “GBL”, BYK-333 (produced by BYK Chemie Japan K.K.) serving as a surfactant was denoted as “BYK-333”, and UC-3000 (produced by TOAGOSEI Co., Ltd.) serving as a binder was denoted as “UC-3000”. The size and shape of metal particles contained in the ink-jet inks prepared in the examples and the comparative examples were substantially the same as those of metal particles contained in the stock solutions, used as raw materials, for producing ink-jet inks. The viscosity of the ink-jet ink, prepared in each example, at 20° C. was within the range of 3 mPa·s to 15 mPa·s as measured in accordance with JIS Z 8809 using a vibrational viscometer.

TABLE 3

| | | | Additional solvent | | | | Surfactant | Binder |
|---|---|---|---|---|---|---|---|---|
| | Stock solution | | DEDG | MEDG | TEGMBE | GBL | BYK-333 | UC-3000 |
| | | Content | Content | Content | Content | Content | Content | Content |
| | | [mass | [mass | [mass | [mass | [mass | [mass | [mass |
| | Type | percent] | percent] | percent] | percent] | percent] | percent] | percent] |
| Example B1 | Example A1 | 30.0 | 57.5 | 0.0 | 10.0 | 2.0 | 0.2 | 0.3 |
| Example B2 | Example A2 | 20.0 | 67.6 | 0.0 | 10.0 | 2.0 | 0.2 | 0.2 |
| Example B3 | Example A2 | 30.0 | 57.5 | 0.0 | 10.0 | 2.0 | 0.2 | 0.3 |
| Example B4 | Example A2 | 40.0 | 47.4 | 0.0 | 10.0 | 2.0 | 0.2 | 0.4 |
| Example B5 | Example A2 | 30.0 | 0.0 | 57.5 | 10.0 | 2.0 | 0.2 | 0.3 |
| Example B6 | Example A2 | 30.0 | 27.5 | 30.0 | 10.0 | 2.0 | 0.2 | 0.3 |
| Example B7 | Example A3 | 30.0 | 57.5 | 0.0 | 10.0 | 2.0 | 0.2 | 0.3 |
| Example B8 | Example A4 | 30.0 | 57.5 | 0.0 | 10.0 | 2.0 | 0.2 | 0.3 |
| Example B9 | Example A5 | 30.0 | 57.5 | 0.0 | 10.0 | 2.0 | 0.2 | 0.3 |
| Example B10 | Example A6 | 30.0 | 57.5 | 0.0 | 10.0 | 2.0 | 0.2 | 0.3 |
| Example B11 | Example A7 | 30.0 | 57.5 | 0.0 | 10.0 | 2.0 | 0.2 | 0.3 |
| Example B12 | Example A8 | 30.0 | 57.5 | 0.0 | 10.0 | 2.0 | 0.2 | 0.3 |
| Example B13 | Example A9 | 30.0 | 57.5 | 0.0 | 10.0 | 2.0 | 0.2 | 0.3 |
| Example B14 | Example A10 | 30.0 | 57.5 | 0.0 | 10.0 | 2.0 | 0.2 | 0.3 |

TABLE 4

| | | | Additional solvent | | | | Surfactant | Binder |
|---|---|---|---|---|---|---|---|---|
| | Stock solution | | DEDG | MEDG | TEGMBE | GBL | BYK-333 | UC-3000 |
| | | Content | Content | Content | Content | Content | Content | Content |
| | | [mass | [mass | [mass | [mass | [mass | [mass | [mass |
| | Type | percent] | percent] | percent] | percent] | percent] | percent] | percent] |
| Example B15 | Example A11 | 30.0 | 57.5 | 0.0 | 10.0 | 2.0 | 0.2 | 0.3 |
| Example B16 | Example A12 | 30.0 | 57.5 | 0.0 | 10.0 | 2.0 | 0.2 | 0.3 |
| Example B17 | Example A13 | 30.0 | 57.5 | 0.0 | 10.0 | 2.0 | 0.2 | 0.3 |
| Example B18 | Example A14 | 30.0 | 57.5 | 0.0 | 10.0 | 2.0 | 0.2 | 0.3 |
| Example B19 | Example A15 | 30.0 | 57.5 | 0.0 | 10.0 | 2.0 | 0.2 | 0.3 |
| Example B20 | Example A16 | 30.0 | 57.5 | 0.0 | 10.0 | 2.0 | 0.2 | 0.3 |
| Example B21 | Example A17 | 30.0 | 57.5 | 0.0 | 10.0 | 2.0 | 0.2 | 0.3 |
| Example B22 | Example A18 | 30.0 | 57.5 | 0.0 | 10.0 | 2.0 | 0.2 | 0.3 |
| Comparative | Comparative | 30.0 | 57.5 | 0.0 | 10.0 | 2.0 | 0.2 | 0.3 |
| Example B1 | Example A1 | | | | | | | |
| Comparative | Comparative | 31.0 | 56.5 | 0.0 | 10.0 | 2.0 | 0.2 | 0.3 |
| Example B2 | Example A2 | | | | | | | |
| Comparative | Comparative | 32.0 | 55.5 | 0.0 | 10.0 | 2.0 | 0.2 | 0.3 |
| Example B3 | Example A3 | | | | | | | |
| Comparative | Comparative | 30.0 | 57.5 | 0.0 | 10.0 | 2.0 | 0.2 | 0.3 |
| Example B4 | Example A4 | | | | | | | |
| Comparative | Comparative | 30.0 | 57.5 | 0.0 | 10.0 | 2.0 | 0.2 | 0.3 |
| Example B5 | Example A5 | | | | | | | |

### 5. Evaluation

### 5-1. Discharge Stability

A droplet-discharging apparatus was prepared and was installed in a thermal chamber. Droplets of the ink-jet ink prepared in each of the examples and the comparative examples were discharged from all nozzles, having a hole diameter of 22 μm, in a droplet-discharging head in a 20° C., 50% RH environment with the frequency of a piezoelectric element varied in such a state that the driving waveform of the piezoelectric element was optimized. The time for which the droplets were discharged at each frequency was set to 20 minutes. The frequency at which the number of nozzles discharging no droplets at the point in time after the droplets were discharged for 20 minutes was less than 0.5% of the number of all the nozzles was defined as the maximum frequency. The available frequency band was evaluated in accordance with four standards below. It can be said that as this value is larger, frequency characteristics are more excellent. A rating of C or higher was a good level.
A: 15 kHz or more.
B: 11 kHz to less than 15 kHz.
C: 5 kHz to less than 11 kHz.
D: less than 5 kHz.

### 5-2. Glossiness of Recording Article

First, a recording article was manufactured using the ink-jet ink prepared in each of the examples and the comparative examples as described below.

That is, the ink-jet ink was charged into an ink jet device and a print portion was formed on a plate-shaped recording medium, made of polycarbonate, having a thickness of 2 mm with a duty of 90% by discharging the ink-jet ink from the ink jet device, whereby the recording article was obtained. Incidentally, a duty of 100% was set to an adhesion amount of about 8 mg/inch².

The print portion of the recording article obtained using the ink-jet ink prepared in each of the examples and the comparative examples was measured for glossiness at a tilt angle of 60° using a glossmeter, MINOLTA MULTI GLOSS 268, and was evaluated in accordance with standards below. It can be said that as this value is larger, the gloss is more excellent. A rating of C or higher was a good level.
A: A glossiness of 450 or more.
B: A glossiness of 430 to less than 450.
C: A glossiness of 400 to less than 430.
D: A glossiness of 350 to less than 400.
E: A glossiness of less than 350.

### 5-3. Evaluation of Storage Stability

### 5-3-1. Heating of Ink-Jet Ink

The ink-jet inks obtained in the examples and the comparative examples were heated at 60° C. for ten days and were then gradually cooled to room temperature.

Thereafter, recording articles were manufactured using the heated ink-jet inks in the same manner as that described in Item (5-2).

The recording articles obtained as described above were visually observed and were evaluated in accordance with standards below. A rating of B or higher was a good level.

A: An excellent gloss is exhibited and gloss unevenness is not at all recognized.

B: An excellent gloss is exhibited and gloss unevenness is hardly recognized.

C: A gloss appearance is poor or gloss unevenness is clearly recognized.

### 5-3-2. Heating of Stock Solution for Producing Ink-Jet Inks

The stock solutions, obtained in the examples and the comparative examples, for producing ink-jet inks, that is, the stock solutions, obtained in Examples A1 to A18 and Comparative Example A1 to A5, for producing ink-jet inks were heated at 60° C. for ten days and were then gradually cooled to room temperature.

Next, 27 types of ink-jet inks corresponding to Examples B1 to B22 and Comparative Examples B1 to B5 were produced in substantially the same manner as the above except that the heated stock solutions for producing ink-jet inks were used.

Thereafter, recording articles were manufactured using these heated ink-jet inks in the same manner as that described in Item (5-2).

The recording articles obtained as described above were visually observed and were evaluated in accordance with standards below. A rating of B or higher was a good level.

A: An excellent gloss is exhibited and gloss unevenness is not at all recognized.

B: An excellent gloss is exhibited and gloss unevenness is hardly recognized.

C: A gloss appearance is poor or gloss unevenness is clearly recognized.

These results are shown in Tables 5 and 6.

TABLE 5

| | | | Storage stability | |
|---|---|---|---|---|
| | | Glossiness of | Heating of | Heating of |
| | Discharge | recording | ink-jet | stock |
| | stability | article | ink | solution |
| Example B1 | C | B | B | B |
| Example B2 | A | C | A | A |
| Example B3 | A | A | A | A |
| Example B4 | C | A | A | A |
| Example B5 | A | A | A | A |
| Example B6 | A | A | A | A |
| Example B7 | A | C | A | A |
| Example B8 | B | A | B | B |
| Example B9 | A | A | A | A |
| Example B10 | A | A | A | A |
| Example B11 | A | B | A | A |
| Example B12 | A | A | A | A |
| Example B13 | A | A | A | A |
| Example B14 | A | C | A | A |

TABLE 6

| | | | Storage stability | |
|---|---|---|---|---|
| | | Glossiness of | Heating of | Heating of |
| | Discharge | recording | ink-jet | stock |
| | stability | article | ink | solution |
| Example B15 | A | C | A | A |
| Example B16 | B | A | B | B |
| Example B17 | A | A | A | A |
| Example B18 | C | B | B | B |
| Example B19 | A | A | A | A |
| Example B20 | A | A | A | A |
| Example B21 | A | A | A | A |
| Example B22 | A | A | A | A |
| Comparative | D | E | C | C |
| Example B1 | | | | |
| Comparative | D | D | C | C |
| Example B2 | | | | |
| Comparative | A | E | C | C |
| Example B3 | | | | |
| Comparative | A | D | C | C |
| Example B4 | | | | |
| Comparative | D | D | C | C |
| Example B5 | | | | |

As is clear from Tables 5 and 6, the ink-jet inks prepared in the examples, that is, ink jet compositions were excellent in discharge stability and allowed the recording articles manufactured using the ink jet compositions to have an excellent gloss appearance. Even after the ink jet compositions were stored under severe conditions, the ink jet compositions were excellent in discharge stability and allowed recording articles to have an excellent gloss appearance. From this, it is conceivable that, not only after an ink jet composition according to the present disclosure is stored under severe conditions but also after the ink jet composition is stored for a long period of time, the ink jet composition can maintain excellent discharge stability and allows a recording article manufactured using the ink jet composition to have an excellent gloss appearance. However, in the comparative examples, no satisfactory results were obtained.

What is claimed is:

1. An ink jet composition containing:
a plurality of metal particles;
a hydrophobic phosphorus surface treatment agent;
a polyoxyalkyleneamine compound; and
a solvent, wherein
the amount of the contained polyoxyalkyleneamine compound is 0.5 parts by mass to 50 parts by mass per 100 parts by mass of the metal particles.

2. The ink jet composition according to claim 1, wherein the polyoxyalkyleneamine compound is at least one selected from the group consisting of a compound represented by the following formula (1), a salt thereof, a compound represented by the following formula (2), and a slat thereof: 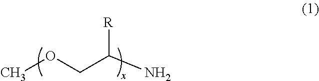
where R is a hydrogen atom or an alkyl group containing three or less carbon atoms, x is an integer of 10 or more, and a plurality of types of oxyalkylene units different in condition of R may be present in Formula (1) and 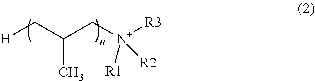
where R1, R2, and R3 are independently an alkyl group containing three or less carbon atoms and n is an integer of 10 or more.

3. The ink jet composition according to claim 1, wherein the metal particles are made of aluminium or an aluminium alloy.

4. The ink jet composition according to claim 1, wherein the volume-average size of the metal particles is 0.20 μm to 1.00 μm.

5. The ink jet composition according to claim 1, wherein the metal particles have a flake shape.

6. The ink jet composition according to claim 5, wherein the average thickness of the metal particles is 10 nm to 90 nm.

7. The ink jet composition according to claim 1, wherein the hydrophobic phosphorus surface treatment agent is a fluorinated phosphorus compound.
